(19) United States
(12) Patent Application Publication
(10) Pub. No.: US 2015/0308663 A1
(43) Pub. Date: Oct. 29, 2015

(54) ZOOM OPTICAL SYSTEM FOR AN AUTOMATED LUMINAIRE

(71) Applicants: Pavel JURIK, Austin, TX (US); Josef VALCHAR, Austin, TX (US)

(72) Inventors: Pavel JURIK, Austin, TX (US); Josef VALCHAR, Austin, TX (US)

(21) Appl. No.: 14/386,312

(22) PCT Filed: Mar. 18, 2013
(86) PCT No.: PCT/US13/32847

§ 371 Date: Sep. 18, 2014

Related U.S. Application Data
(60) Provisional application No. 61/612,371, filed on Mar. 18, 2012.

(51) Int. Cl. F21V 14/06; F21V 17/00

(52) U.S. Cl. CPC F21V 14/06; F21V 17/007; F21W 2131/406

(57) ABSTRACT

Described are an improved automated luminaire 12 and luminaire systems 10 employing an improved output lens system 30 and carrier 32. The output lens 30 may be extended along the optical axis outside the frontal confines of the chassis of the luminaire in order to provide an improved narrow angle performance from the optical systems.

### RELATED APPLICATION

This application is a utility application claiming priority of United States provisional application with the same title Ser. No. 61/612,371 filed on 18 Mar. 2012.

### TECHNICAL FIELD OF THE INVENTION

The present invention generally relates to automated luminaires, specifically to optical systems for use within automated luminaires.

### BACKGROUND OF THE INVENTION

Luminaires with automated and remotely controllable functionality are well known in the entertainment and architectural lighting markets. Such products are commonly used in theatres, television studios, concerts, theme parks, night clubs and other venues. A typical product will commonly provide control over the pan and tilt functions of the luminaire allowing the operator to control the direction the luminaire is pointing and thus the position of the light beam on the stage or in the studio. Typically this position control is done via control of the luminaire's position in two orthogonal rotational axes usually referred to as pan and tilt. Many products provide control over other parameters such as the intensity, color, focus, beam size, beam shape and beam pattern. The beam pattern is often provided by a stencil or slide called a gobo which may be a steel, aluminum or etched glass pattern. The products manufactured by Robe Show Lighting such as the ColorSpot 700E are typical of the art.

It is well known to design the optical systems of such automated luminaires such that the output angle of the emitted light beam can be adjusted over a range of values, from a very narrow beam to a wide beam. This beam angle size, or zoom, range allows the lighting designer full control over the size of a projected image, pattern or wash area. One limitation to the range of zoom angles possible in a luminaire is the length of the luminaire. For very narrow zoom angles it is typically required to have a large separation between the final output lens and the image plane of the object being projected. Wide angles conversely are achieved when the output lens is close to the image being projected. However, it is often impractical for rigging, storage and transportation to have a luminaire body that is long enough to accommodate the wide lens separation required for very narrow angles. It may also be problematic to use such a large separation with a large heavy glass output lens as such an arrangement makes the luminaire large and unwieldy and makes automation of the pan and tilt movement difficult. The normal solution to all these concerns is to restrict the minimum achievable beam angle and to use smaller lighter lenses. A short focal length lens if constructed as a conventional glass plano-convex lens needs to be very thick and heavy which may also cause problems with the center of gravity of the luminaire, especially if the lens is moved along the optical axis by motors to provide an automated focus function. As the heavy lens moves the center of gravity of the luminaire is constantly changing and causes problems for the automated pan and tilt systems which are optimized for a balanced mechanical load. Prior art manufacturers attempted to remedy this problem in one of two ways. Firstly, they maintain the heavy front lens static and instead move the gobo, iris and shutter assemblies backwards and forwards. Although these assemblies are also heavy they are closer to the center of gravity of the luminaire so that moving them has less affect on the overall balance. Alternatively the thick heavy plano-convex front lens is replaced with a Fresnel lens where the same focal length is achieved with a much lighter molded glass lens using multiple circumferential facets. Fresnel lenses are well known in the art and can provide a good match to the focal length of an equivalent plano-convex lens, however the image projected by such a lens is typically soft edged and fuzzy and not a sharp image as may be desired. This softness may be caused by the facets on the molded glass Fresnel lens; there are relatively few facets and each one has an edge which, instead of being sharp, is constrained by the molding process and the surface tension of the molten glass during molding to instead have a large radius of curvature. This radius on the tip of each circumferential facet tends to diffuse the light beam and produce a softened image.

FIG. 1 illustrates a multiparameter automated luminaire system 10. These systems commonly include a plurality of multiparameter automated luminaires 12 which typically each contain on-board a light source, light modulation devices, electric motors coupled to mechanical drives systems and control electronics (not shown). In addition to being connected to mains power either directly or through a power distribution system (not shown), each luminaire is connected is series or in parallel to data link 14 to one or more control desks 15. The luminaire system 10 is typically controlled by an operator through the control desk 15.

FIG. 2 illustrates a prior art automated luminaire 11. A lamp 21 contains a light source 22 which emits light. The light is reflected and controlled by reflector 20 through optical devices 26 which may include dichroic color filters, effects glass and other optical devices well known in the art and then through an aperture or imaging gate 24. Optical components 25 are the imaging components and may include gobos, rotating gobos, iris and framing shutters. The beam may then pass through further lenses 26 and 28 before being transmitted through output lens 31. Lenses 26 and 28 may be moved along the optical axis 19 so as to alter the beam angle and focus of the emitted beam. Lenses 26 and 28 are commonly known as the focus and zoom lens, however these common names are really misnomers as both lenses affect both functions. Lens 31 may be a glass lens or equivalent Fresnel lens as described herein. Lens 31 is constrained by the outer dimensions of the luminaire body 16 and may not move further away from the imaging components.

There is a need for an improved zoom lens system for an automated luminaire which provides the user the ability to obtain a wide range of zoom angles, while still providing a compact unit for rigging, storage and transportation.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 illustrates a typical automated lighting system;

FIG. 2 illustrates a prior art automated luminaire;

FIG. 3 illustrates an embodiment of an improved zoom system in an automated luminaire;

FIG. 4 illustrates an embodiment of an improved zoom system in an automated luminaire with output lens extended;

FIG. 5 illustrates an embodiment of an improved zoom system in an automated luminaire with LED light source and output lens extended;

FIG. 6 illustrates an isometric view of an embodiment of the invention;

FIG. 7 illustrates a view of selected components of an embodiment of the invention in wide angle with output lens retracted;

FIG. 8 illustrates a view selected components of an embodiment of the invention in narrow angle with output lens extended;

FIG. 9 illustrates a cut-away view of an embodiment of the invention in wide angle with output lens refracted;

FIG. 10 illustrates a cut-away view of an embodiment of the invention in narrow angle with output lens extended;

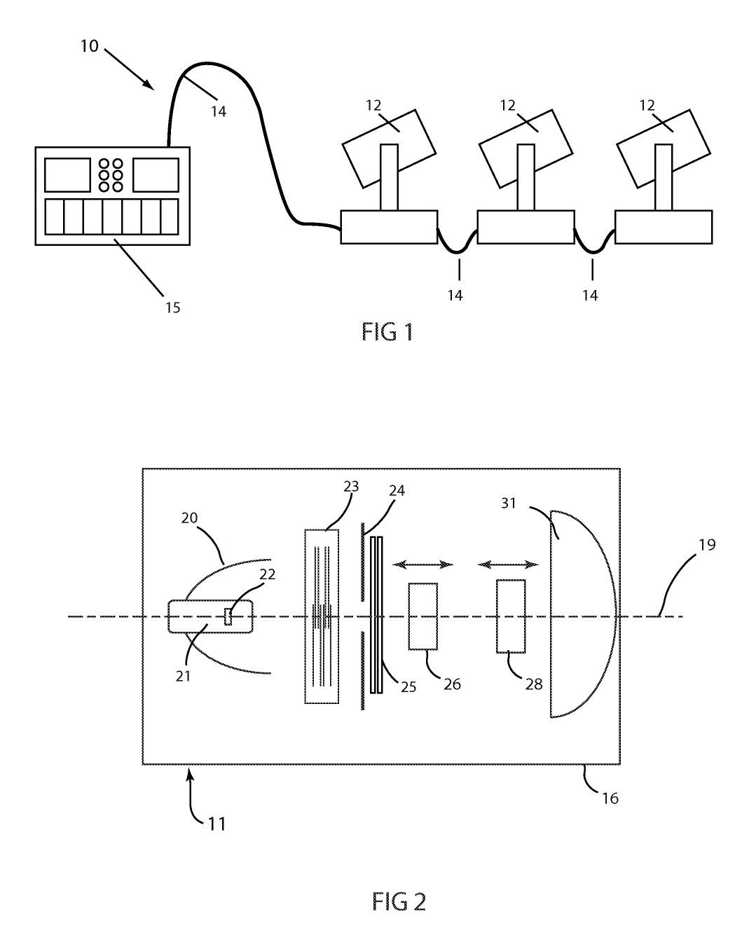

### DETAILED DESCRIPTION OF THE INVENTION

Preferred embodiments of the present invention are illustrated in the FIGUREs, like numerals being used to refer to like and corresponding parts of the various drawings.

The present invention generally relates to an automated luminaire, specifically to the configuration of the optical systems within such a luminaire to provide the ability to obtain a wide range of zoom angles, while still providing a compact unit for rigging, storage and transportation.

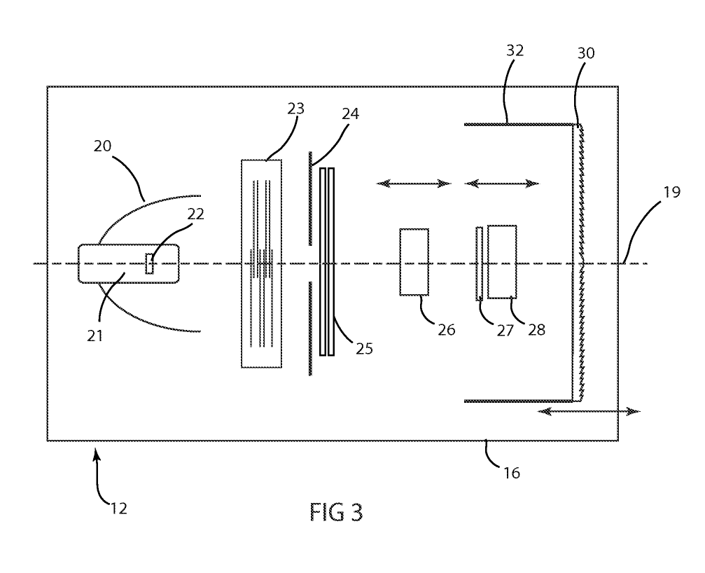

FIG. 3 illustrates an embodiment of an improved zoom system in an automated luminaire. Automated luminaire 12 may contain a lamp 21 and reflector 20 where the lamp and reflector may be moved relative to each other for beam hot-spot control, color modulation components 23 which may include, but are not limited to, color mixing flags or wheels, color wheels and other dichroic color modulation components, an aperture 24 which may be fixed in size or adjustable, imaging optical components 25 which may include but are not limited to gobos, rotating gobos, framing shutters, beam shapers, variable frost filters, prisms and/or iris(s). The light beam from these images is focused by first lens 26, second lens 28 and Fresnel output lens 30. First lens 26 and second lens 28 may each comprise one or more optical elements, all or some of which may be moved backwards and forwards along the optical axis 19 of the luminaire 12 so as to direct light towards output lens 30. First lens 26 and second lens 28 may further homogenize and constrain the light beam and ensure that the light beam entirely fills output lens 30.

First lens 26 and second lens 28 may further homogenize and constrain the light beam. Additionally, in the preferred embodiment the pre-output lenses 26 and 28 are designed in certain spot mode operations to maximize filling the area of the output lens 30 about the operational range of the focus lenses 26, 28 and 30. In the preferred embodiment the movement of the lenses 26, 28 and 30 can be automatically coordinated in order to achieve the maximization of filling the area of the output lens.

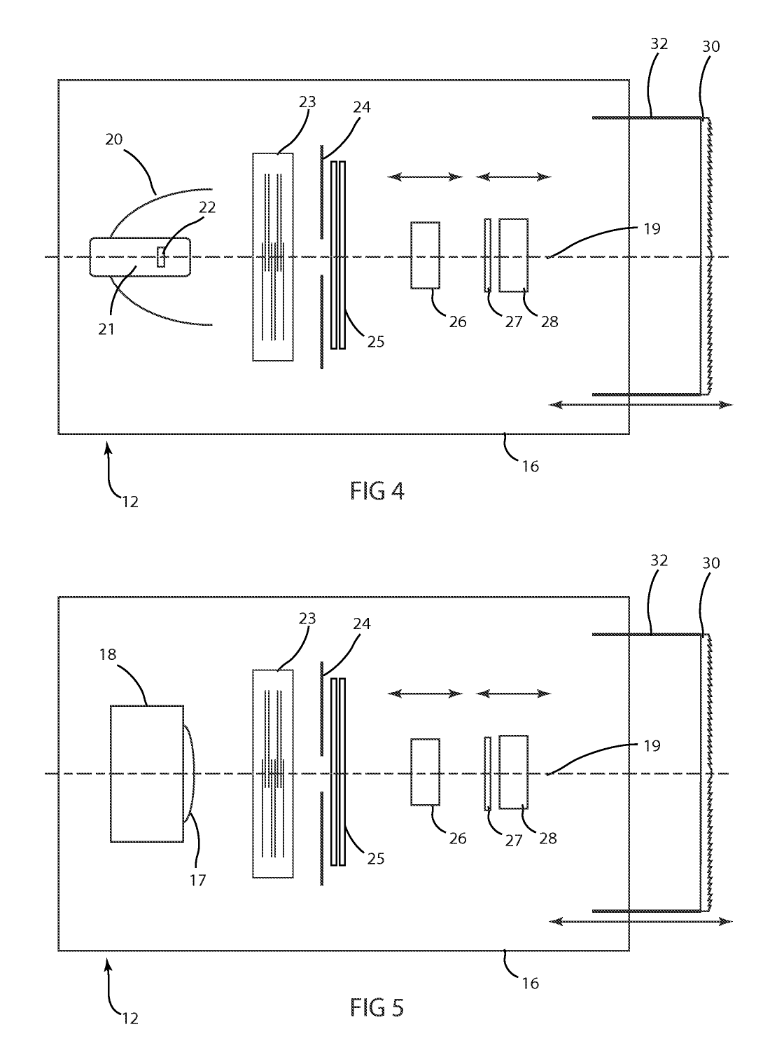

In some embodiments a diffusion filter 27 may also optionally be inserted in the optical path to improve the homogenization and to further increase the maximum output angle Output lens 30 may be a conventional Fresnel lens, an improved Fresnel lens with an increased number of smaller circumferential facets than a standard Fresnel lens, or a standard spherical or aspheric lens. First lens 26, second lens 28 and output lens 30 may be manufactured of glass, suitable transparent polymer such as acrylic or polycarbonate, or any other suitable material. Lens 30 may be moved backwards and forwards along the optical axis 19 of the luminaire 12 so as to provide focus adjustment of the projected images of optical elements 25. The combination of first lens 26, second lens 28 and output lens 30 provide an output beam which is adjustable for both beam angle and focus by moving any or all of first lens 26, second lens 28 and output lens 30 backwards and forwards along optical axis 19. Output lens 30 is attached to a carrier 32 which supports output lens 30 and provides the movement along the optical axis. Carrier 32 may support output lens 30 at one end of carrier 32, this allows carrier 32 to move along the optical axis such that output lens 30 extends out from the front of the luminaire chassis 16 as shown in FIG. 4. FIG. 3 illustrates the system in a wide angle configuration where output lens 30 is positioned inside the luminaire chassis 16 and first and second lenses 26 and 28 move to provide zoom and focus.

FIG. 4 illustrates an embodiment of an improved zoom system in an automated luminaire with output lens extended. The system shown is the same as illustrated in FIG. 3 however output lens 30 has been moved by carrier 32 to a position outside the front of the luminaire chassis 16. FIG. 4 illustrates the system in a narrow angle configuration where output lens 30 is positioned outside the luminaire chassis 16 and first and second lenses 26 and 28 move to provide zoom and focus. Diffusion filter 27 may also optionally be inserted in the optical path to improve the homogenization and to further increase the maximum output angle.

Through the system provided by carrier 32 and output lens 30 the luminaire is capable of providing a very wide range of output beam angles, in one embodiment the described system provides a continuous zoom range of 5.5° in narrow angle to 60° in wide angle. In this specific embodiment, the addition of diffusion filter 27 changes the continuous zoom range to 20° in narrow angle to 75° in wide angle.

FIG. 5 illustrates an embodiment of an improved zoom system in an automated luminaire with output lens extended. In this embodiment the light source is an LED, solid state, light source 18 which may have integrated optics 17. LED light source 18 may be a single color light source comprising, for example, white LEDs, or may comprise multiple colors of LEDs such as red, green and blue (RGB), or red, green, blue and white (RGBW) or any other combination of colored LEDs, whose output may be independently varied and mixed to provide any desired color. The optical system 17 of the light source preferably should provide homogenization of the individual colors such that the output beam is of a single color, with minimized colored patterning or colored shadows. RGB systems may exclusively rely on color modulation of the RGB LED's additively rather than modulation by a color modulation system 23. However, other embodiment of LED sourced systems may incorporate a subtractive color modulation system 23.

FIG. 5 illustrates the system in a narrow angle configuration where output lens 30 is positioned outside the luminaire chassis 16, and first and second lenses 26 and 28 move to provide zoom and focus. Diffusion filter 27 may also optionally be inserted in the optical path to improve the homogenization and to further increase the maximum output angle.

Output lens 30 may be a conventional Fresnel lens or may be a Fresnel lens with a greatly increased number of circumferential facets. Output lens 30 may also be provided with either a planar rear surface or with a break-up or stippling pattern molded into the rear surface. If a Fresnel lens with a planar rear surface is used then the optical system herein disclosed may provide sharply focused images of imaging components 25 whereas a lens with a stippled back will provide softened, diffused images.

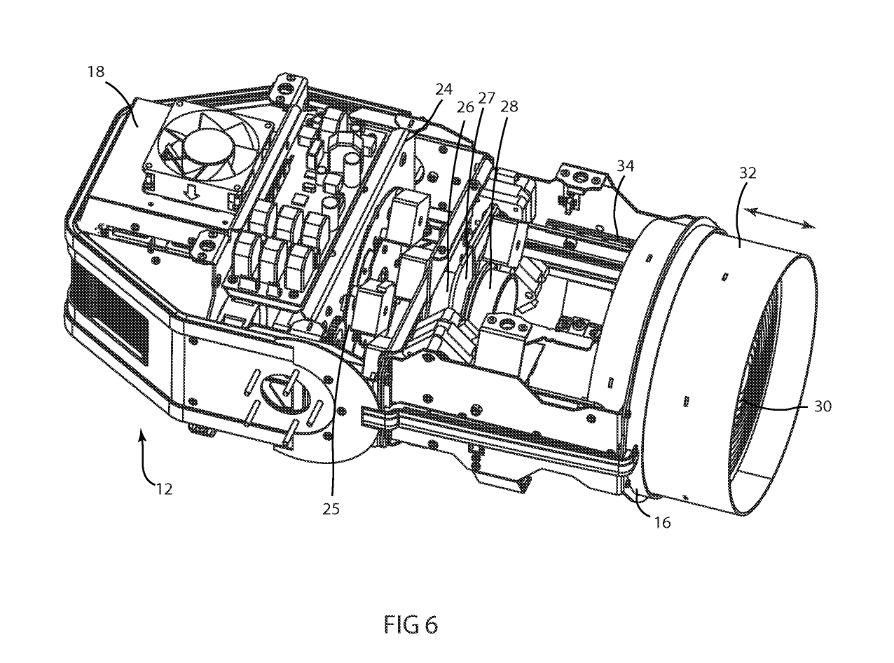

FIG. 6 illustrates an isometric view of an embodiment of the invention with the covers removed. Automated luminaire 12 contains light source 18, an aperture 24 which may be fixed in size or adjustable, imaging optical components 25 which may include but are not limited to gobos, rotating gobos, framing shutters, beam shapers, variable frost filters, prisms and iris. The light beam from these images is focused by first lens 26, second lens 28 and output lens 30. Output lens 30 is mounted in carrier 32 which may move on rails 34 backwards and forwards relative to the frontal confines of the luminaire chassis 16. Such movement may be provided by stepper motors, linear actuators, servo motors or any other suitable controllable means. Diffusion filter 27 may be mounted on an arm or on other articulation means such that it may be inserted or removed from the optical path as desired by the user to improve the homogenization and to further increase the maximum output angle. It is here illustrated removed from the optical path.

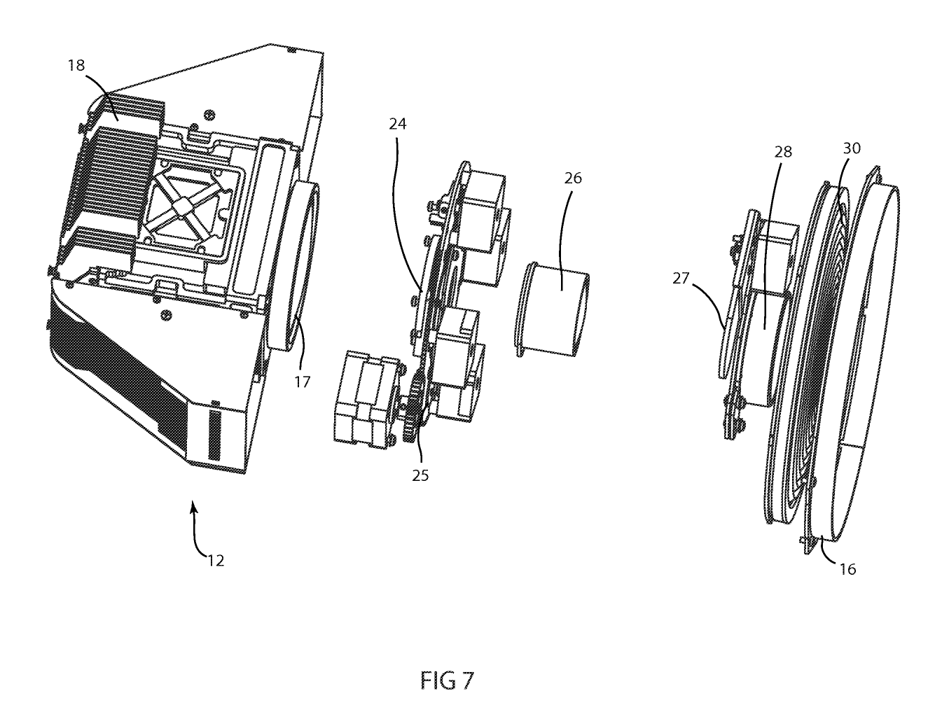

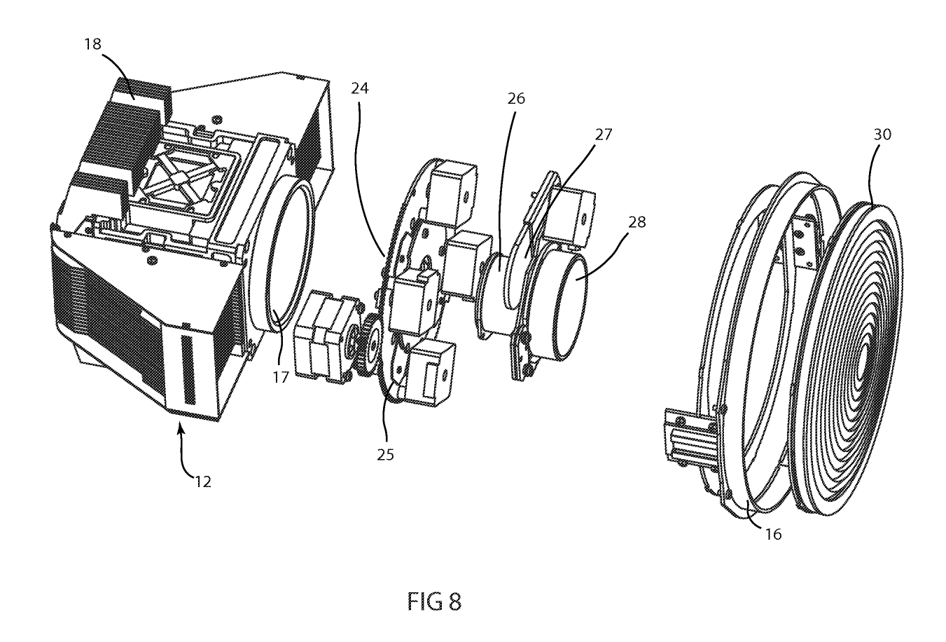

FIG. 7 illustrates a view of selected components of an embodiment of the invention in wide angle configuration with output lens 30 retracted within the frontal confines of the luminaire chassis 16. With output lens 30 in this position the luminaire presents a compact configuration. In the preferred embodiment, when the luminaire is shut down it automatically retracts into this position for easier and safer rigging/de-rigging (installation/de-installation), storage and transported. For maximum wide angle second lens 28 may be positioned close to output lens 30 and first lens 26 may be adjusted to provide focus control. To further increase the beam angle, diffusion filter 27 may be inserted across the optical path.

FIG. 8 illustrates a view of selected components of an embodiment of the invention in narrow angle configuration with output lens 30 extended out past the frontal confines of the luminaire chassis 16. With output lens 30 in this position the luminaire presents an extended configuration for optimal narrow angle and is not in the position for being rigged, stored and transported. For minimum narrow angle, second lens 28 may be positioned far from output lens 30 and first lens 26 may be adjusted to provide focus control.

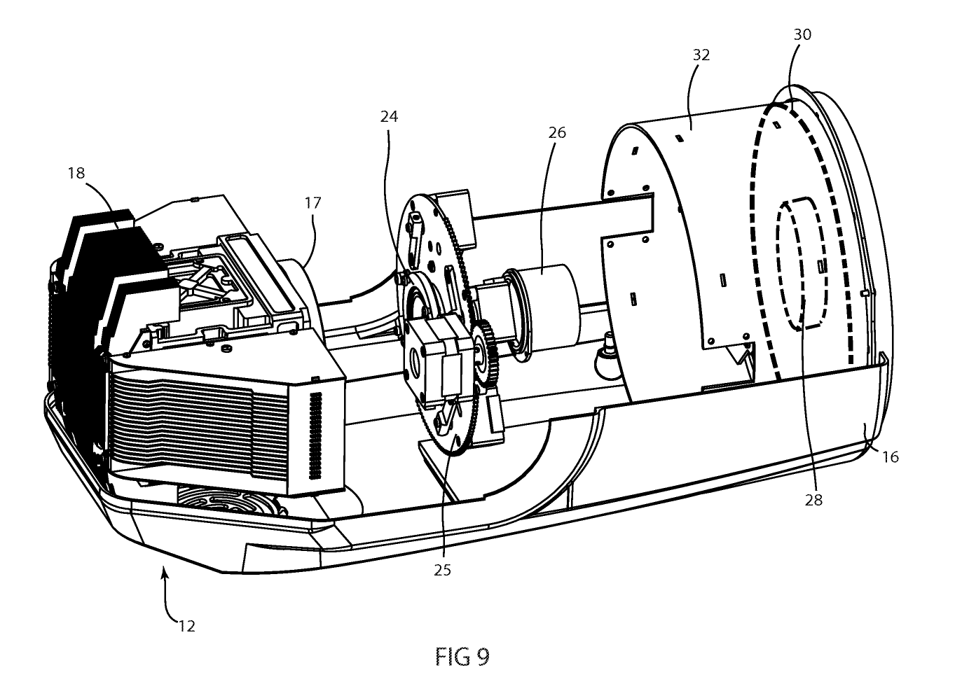

FIG. 9 illustrates a cut-away view of an embodiment of the invention in wide angle configuration with output lens 30 and carrier 32 shown retracted within the frontal confines of the luminaire chassis 16. With output lens 30 in this position the luminaire presents a compact configuration and may be readily and optimally rigged, stored and transported. For maximum wide angle second lens 28 may be positioned close to output lens 30 and first lens 26 may be adjusted to provide focus control.

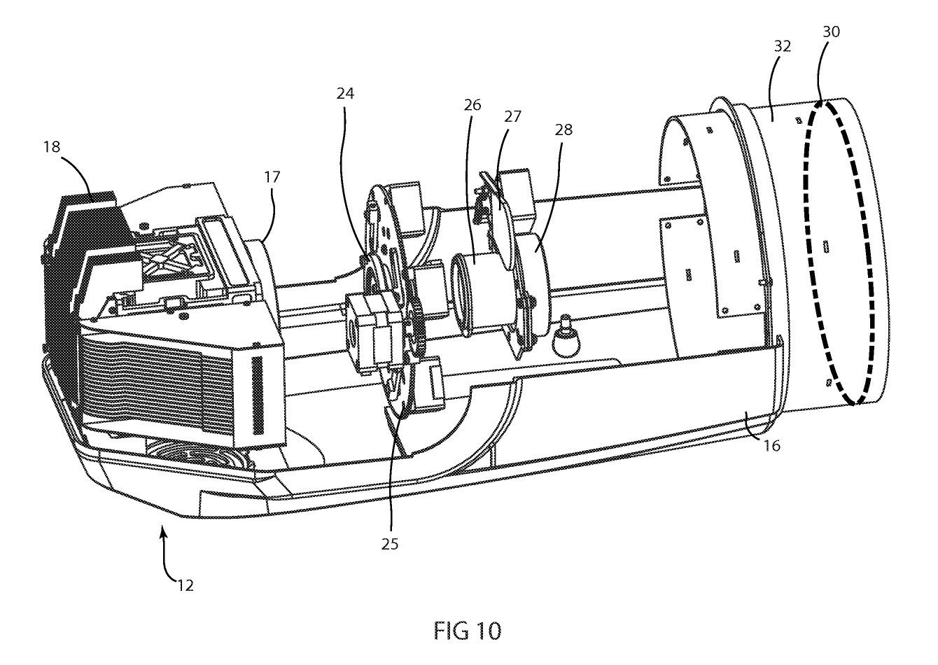

FIG. 10 illustrates a cut-away view of an embodiment of the invention in narrow angle configuration with output lens 30 and carrier 32 shown extended out past the frontal confines of the luminaire chassis 16. With output lens 30 in this position the luminaire presents an extended configuration for optimal narrow angle and is not in the optimal position for being rigged, stored and transported. For minimum narrow angle, second lens 28 may be positioned far from output lens 30 and first lens 26 may be adjusted to provide focus control.

The invention as disclosed provides an optical system capable of large zoom ranges while still presenting a compact luminaire that is easy to rig, store and transport. When in the compact configuration, output lens 30 is protected within the chassis 16 and the luminaire may be placed inside a road case or truss for transportation. After rigging, lens carrier 32 and output lens 30 may extend outside the luminaire chassis 16 so as to provide an improved narrow beam angle, The combination of first lens 26, second lens 28 and output lens 30, any or all of which may move along the optical axis, provides optimal and continuous control of both beam angle and focus.

While the disclosure has been described with respect to a limited number of embodiments, those skilled in the art, having benefit of this disclosure, will appreciate that other embodiments may be devised which do not depart from the scope of the disclosure as disclosed herein. The disclosure has been described in detail, it should be understood that various changes, substitutions and alterations can be made hereto without departing from the spirit and scope of the disclosure.

1. An automated luminaire with and output lens which in operation is articulatable to extend out beyond the frontal confines of the luminaire and when not in operation retracts within the confines of the luminaire.

2. The automated luminaire of claim 1 wherein the retraction takes place automatically as part of a shutdown procedure.
